(19) United States
(12) Patent Application Publication
(10) Pub. No.: US 2021/0135924 A1
(43) Pub. Date: May 6, 2021

(54) NETWORK MONITORING SYSTEM AND METHOD, AND NON-TRANSITORY COMPUTER READABLE MEDIUM STORING PROGRAM

(71) Applicant: NEC CORPORATION, Tokyo (JP)

(72) Inventor: Riichirou EBISAWA, Tokyo (JP)

(73) Assignee: NEC CORPORATION, Tokyo (JP)

(21) Appl. No.: 16/962,925

(22) PCT Filed: Oct. 12, 2018
(86) PCT No.: PCT/JP2018/038030

§ 371 Date: Jul. 17, 2020

(30) Foreign Application Priority Data
Jan. 19, 2018 (JP) 2018-007568

(51) Int. Cl. H04L 12/24; H04L 12/26

(52) U.S. Cl. CPC H04L 41/069; H04L 41/0631; H04L 43/0817

(57) ABSTRACT

A network monitoring system (10) according to the example embodiments that monitors a monitoring target equipment connected via a network includes: a network monitoring device (11) configured to acquire a plurality of monitoring data related to states of the monitoring target equipment (21), (22), (23) at respective prescribed monitoring frequencies; an analysis engine (13) configured to analyze the plurality of monitoring data up to a time of occurrence of failures in the monitoring target equipment (21), (22), (23) and create sign information of the occurrence of the failures every time failures occur in the monitoring target equipment; and a storage device configured to accumulate the sign information that is created, in which the analysis engine (13) changes each of the monitoring frequencies of the plurality of monitoring data based on the sign information that is accumulated.

### TECHNICAL FIELD

The present disclosure relates to network monitoring system and method, and a non-transitory computer readable medium storing a program.

### BACKGROUND ART

Recently, many network equipment such as routers, switches, etc. and terminal devices such as a server machine, a client machine etc.

are connected to a network for various purposes to configure a network system. In order to safely perform maintenance of this kind of network system, a network monitoring device that monitors the network system continuously on a periodic basis is used.

Patent Literature 1 discloses a network monitoring device that performs monitoring in accordance with a monitoring policy defining monitoring targets, monitoring items, prescribed monitoring intervals, and the like. In the network monitoring device, when as many monitoring targets and monitoring items as possible are thoroughly monitored, a large load is placed on the whole network system and thus, in Patent Literature 1, a technique of changing the monitoring policy dynamically in accordance with the state of the network system is proposed in Patent Literature 1.

This network monitoring device calculates the predicted monitoring data indicating the future state based on the past and/or the present monitoring data obtained in accordance with the monitoring policy, and dynamically changes the monitoring policy based on the predicted monitoring data. For example, based on the response time of each measurement day in the past, the predicted monitoring data of a prediction model that uses an approximation is calculated, and a monitoring item is added based on the predicted monitoring data. Further, in order to minimize the load placed on the monitoring target and the like, the newly added monitoring item is deleted when it is determined that there is no failure.

### CITATION LIST

### Patent Literature

Patent Literature 1: Japanese Unexamined Patent Application Publication No. 2010-141655

### SUMMARY OF INVENTION

### Technical Problem

In Cited Document 1, the monitoring target and the monitoring items in which, statistically, failures occur relatively often, are monitored with high frequency. However, when the frequency of occurrence of failures lowers relatively owing to high-functionalization of the equipment, the device, and the like that configure the network system, the amount of the monitoring data that is acquired for statistically predicting occurrence of failures reduces. Therefore, the network band might be congested by the acquired monitoring data unless the monitoring data is acquired efficiently. Further, the network equipment affect each other as the network system becomes complicated, resulting in difficulty in predicting occurrence of failures. An object of the present disclosure is to provide network monitoring system and method that solve the aforementioned problem and a non-transitory computer readable medium storing a program.

### Solution to Problem

According to an example aspect, a network monitoring system that monitors a monitoring target equipment connected via a network, includes:

a network monitoring device configured to acquire a plurality of monitoring data related to a state of the monitoring target equipment at respective prescribed monitoring frequencies;

an analysis device configured to analyze the plurality of monitoring data up to a time of occurrence of a failure in the monitoring target equipment and create sign information of the occurrence of the failure every time a failure occurs in the monitoring target equipment; and

a storage device configured to accumulate the sign information that is created, in which

the analysis device changes each of the monitoring frequencies of the plurality of monitoring data based on the sign information that is accumulated.

### Advantageous Effects of Invention

According to the present disclosure, it is possible to prevent an increase in a load imposed on a network due to acquisition of plurality of monitoring data as well as to suppress delay in detection of failures.

### BRIEF DESCRIPTION OF DRAWINGS

FIG. 1 is a diagram showing a configuration of a network monitoring system according to an example embodiment;

FIG. 2 is a diagram describing a network monitoring method according to an example embodiment;

FIG. 3 is a diagram describing a network monitoring method according to an example embodiment;

FIG. 4 is diagram describing a network monitoring method according to an example embodiment; and

FIG. 5 is diagram describing a network monitoring method according to an example embodiment.

### DESCRIPTION OF EMBODIMENTS

The present disclosure relates to network monitoring system and method that detect occurrence of a failure in a monitoring target equipment that is connected via a network and a non-transitory computer readable medium storing a program, and more specifically, to a technique of controlling the acquisition frequencies of the plurality of monitoring data at each monitoring point where there is a possibility of occurrence of a failure. There are many monitoring points where failures occur in the network system and a large load is imposed on the monitoring target equipment, the monitoring network, and the monitoring server in monitoring the state of every monitoring point at the maximum frequency, causing an increase in the cost of the network monitoring system. In the network monitoring system according to the present disclosure, an increase in the load imposed on the network due to acquisition of the plurality of monitoring data is prevented as well as a delay in the detection of the failures is suppressed by grasping the correlation among the monitoring data related to the failures.

Hereinafter, example embodiments of the present disclosure will be described with reference to the drawings. For clarifying the explanation, the following description and the drawings are partially omitted and simplified where appropriate. Further, each element shown in the drawings as a functional block that performs various processing can be configured of a CPU, a memory, and other circuits in terms of hardware. Further, the present disclosure can implement an arbitrary processing by causing the CPU (Central Processing Unit) to execute a computer program. Therefore, a skilled person can understand that these functional blocks can be implemented by a hardware configuration, a software configuration, or a combination thereof, and it is not to be limited to any one of them.

The aforementioned program can be stored and provided to a computer using any type of non-transitory computer readable media. Non-transitory computer readable media include any type of substantial tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

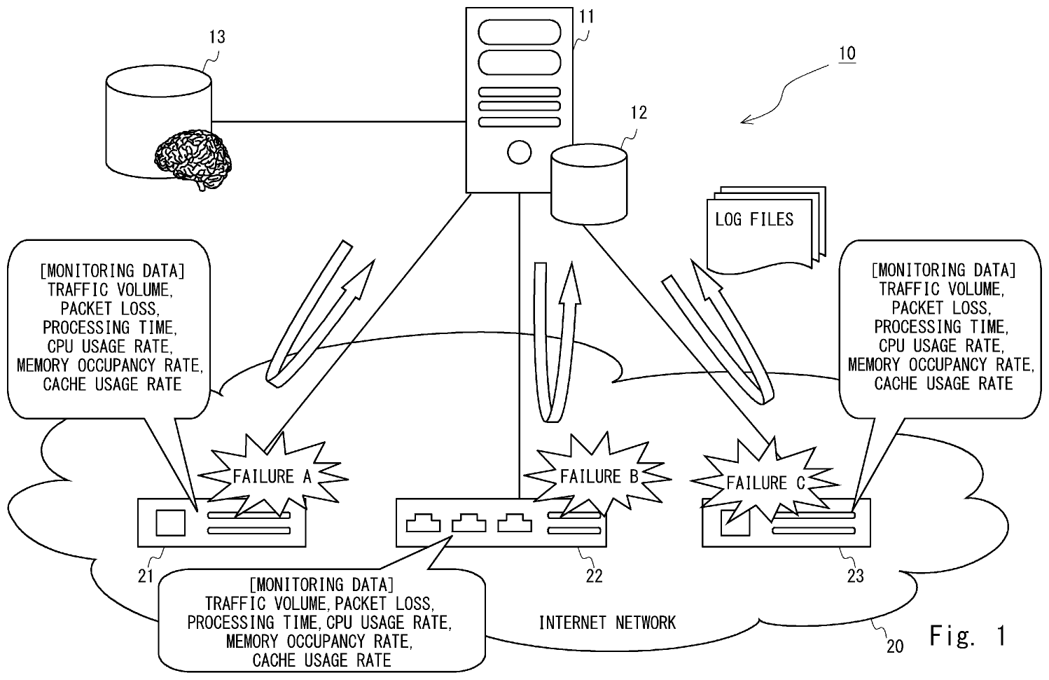

FIG. 1 is a diagram showing a configuration of a network monitoring system 10 according to an example embodiment. As shown in FIG. 1, the network monitoring system 10 includes a network monitoring device 11, a database (a storage device) 12, and an analysis engine (an analysis device) 13. Network equipment (monitoring target equipment) 21, 22, and 23 such as a switch, a router and the like are connected to the network monitoring device 11 via an internet network (a network) 20. The network monitoring device 11 monitors a plurality of monitoring points (monitoring targets) where failures may possibly occur in the network system continuously on a periodic basis in order to safely perform maintenance of the network system.

The network monitoring device 11 acquires a plurality of monitoring data (monitoring items) related to the states of the network equipment 21, 22, and 23 at respective prescribed monitoring frequencies. As the monitoring data, a traffic volume, a packet loss amount, a packet processing time etc. can be given as the data related to the performance, and a CPU usage rate, a memory occupancy rate, and a cache usage rate can be given as the data related to the resource. In each of the network equipment 21, 22, and 23, a plurality of monitoring data thereof are measured constantly and log files in which these monitoring data are recorded are held. The network monitoring device 11 acquires each log file of the plurality of monitoring data held in the network equipment 21, 22, and 23 at a prescribed

The analysis engine 13 is connected to the network monitoring device 11 in order to appropriately adjust the monitoring frequencies of the network equipment 21, 22, and 23. Every time failures occur in the network equipment 21, 22, and 23, the analysis engine 13 analyzes the behavior (the temporal transition) of the plurality of monitoring data up to the time of occurrence of failures in the network equipment 21, 22, and 23, and creates an analysis result on a regular basis. The analysis result is sign information for detecting signs of occurrence of failures in the network equipment 21, 22, and 23. The created sign information is accumulated in the database 12.

The analysis engine 13 performs, for example, an invariant analysis. The invariant analysis is an analyzing method of detecting a “difference” by learning the normal pattern in which the invariant among the plurality of monitoring data is modeled and comparing the normal pattern and the monitoring data to be analyzed. The analysis engine 13 determines that an abnormality has occurred when the monitoring data to be analyzed differs from the normal pattern. Further, the analysis engine 13 changes the monitoring frequency of each of the plurality of monitoring data using the accumulated sign information. That is, the analysis engine 13 feeds back the analysis result to its own system and adjusts the monitoring frequency of each monitoring data to a more appropriate value as it learns the behavior of each monitoring data in order to perform the invariant analysis.

In the example embodiment, the analysis engine 13 learns the behavior of the plurality of monitoring data in each of a stable state in which no failure has occurred, a sign-indication state in which a failure is about to occur, and an abnormality state in which a failure has occurred, and determines which one of the stable state, the sign-indication state, or the abnormality state each of the network equipment is in. There are two modes in monitoring the network equipment in the network monitoring system 10. One of the modes is a stable monitoring mode in which all of the plurality of monitoring data at every monitoring point are acquired while the network system is operating normally in the stable state. The other mode is the sign monitoring mode in which only the relevant monitoring data related to the failure is acquired in the sign-indication state. The network monitoring system 10 is operated by switching between these two monitoring modes.

In either one of the monitoring modes, the monitoring frequency of each monitoring data is optimized so that the monitoring traffic volume per unit time is made substantially constant. That is, the sum of the monitoring data per unit time before the monitoring frequencies are changed and the sum of the monitoring data per unit time after the monitoring frequencies are changed are roughly equal. Transition from the stable monitoring mode to the sign monitoring mode is performed based on the result of analysis of the monitoring data performed by the analysis engine 13. Transition from the sign monitoring mode to the stable monitoring mode is performed as the network monitoring device 11 detects that the network equipment in which a failure has occurred is restored due to replacement of the equipment or the like.

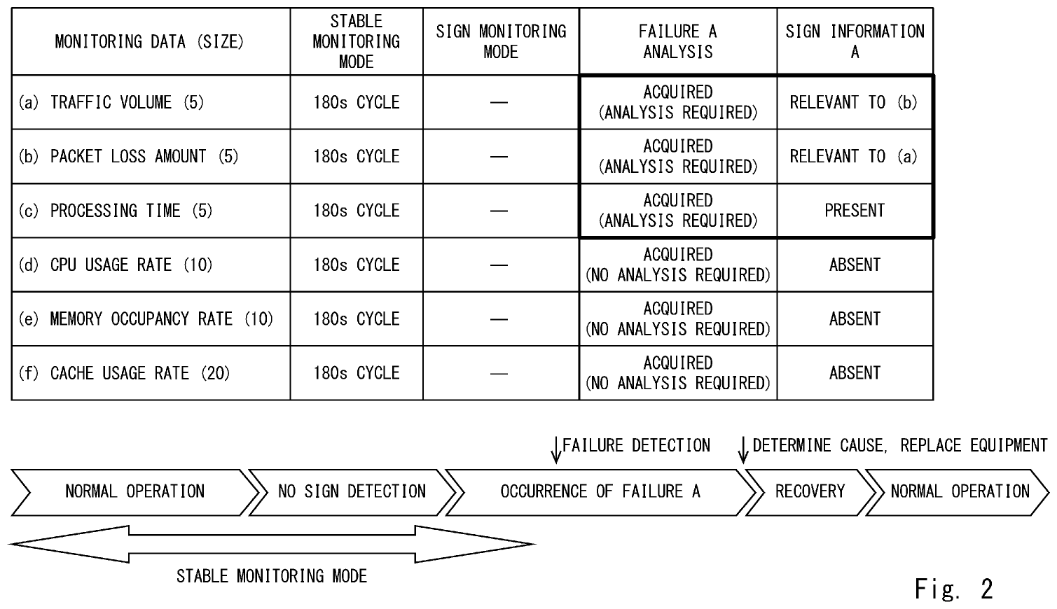

Here, FIGS. 2 to 5 that describe the network monitoring method according to the example embodiment are figures that describe the network monitoring method according to the example embodiment. In FIGS. 2 to 5, the table shown at the top lists the monitoring frequency (a cycle (s)) of each monitoring data in the stable monitoring mode and the sign monitoring mode, whether or not it is necessary to analyze the monitoring data acquired when a failure has occurred, and the sign information. Further, the diagram shown at the bottom indicates the operations performed by the network monitoring system 10 of monitoring the network equipment 21, 22, and 23 and restoring the network equipment 21, 22, and 23 after the failures have occurred therein.

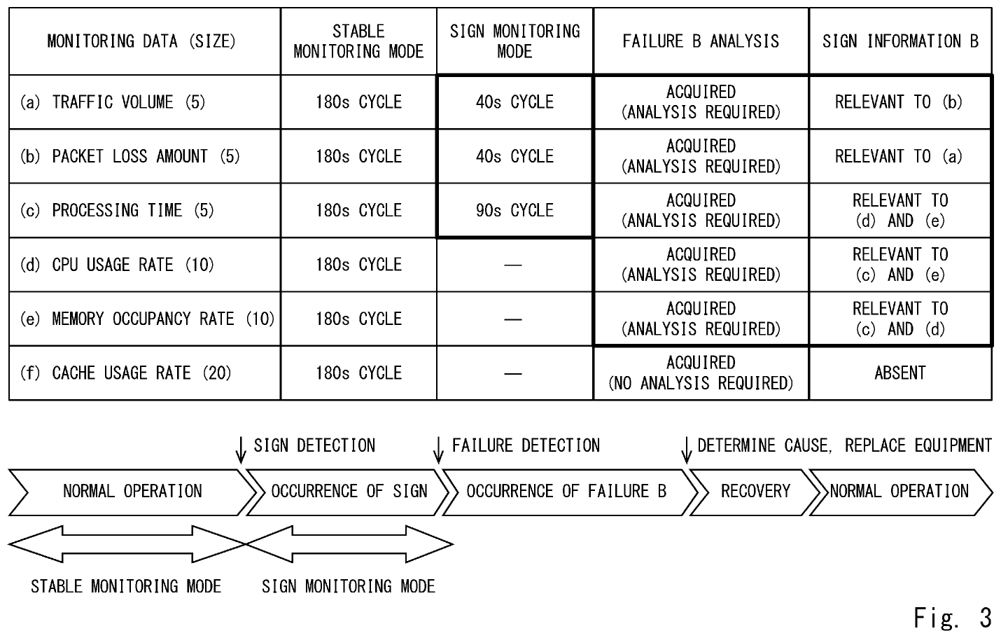

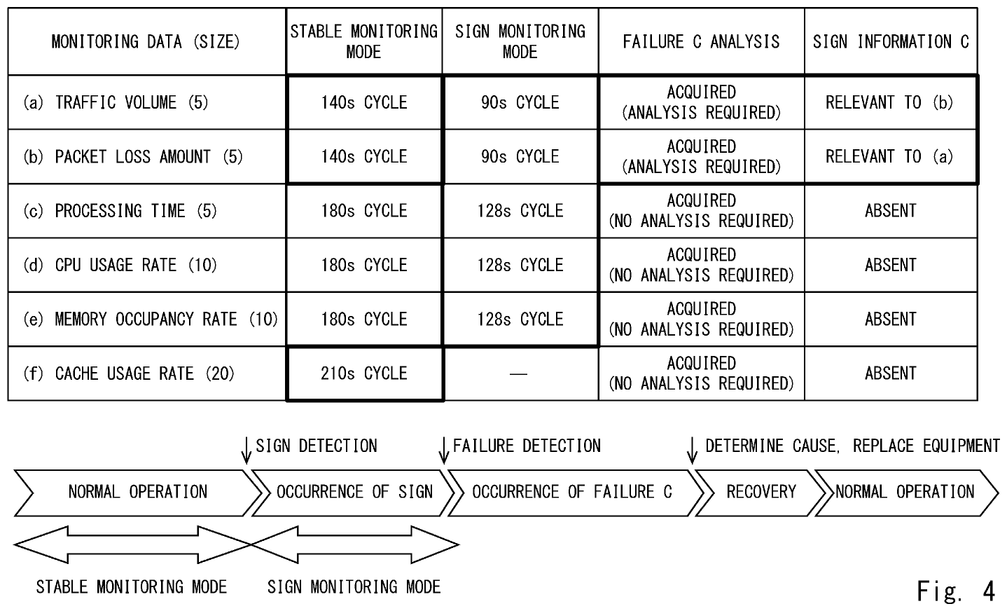

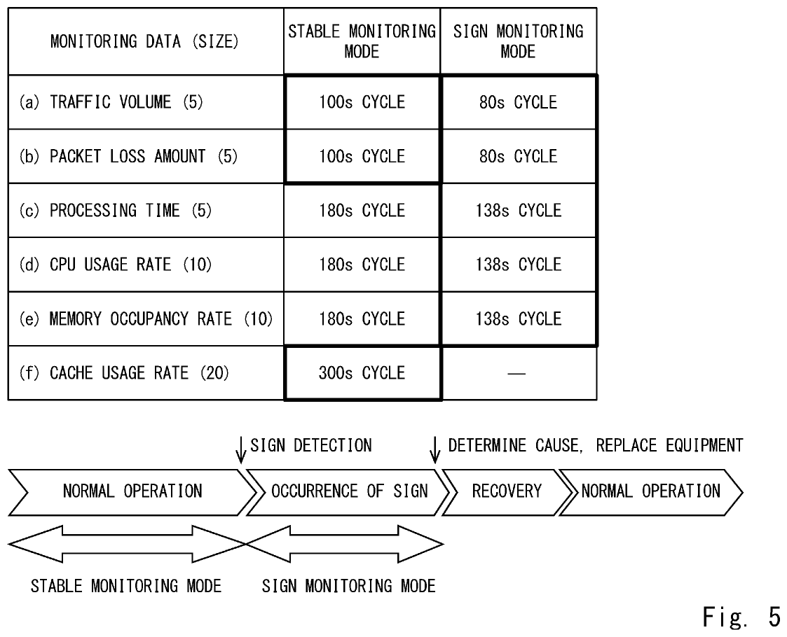

Further, transition of the operations shown in each of the FIGS. 2 to 5 is performed successively timewise. That is, after a failure A shown in FIG. 2 occurs and then restored therefrom, a failure B shown in FIG. 3 occurs and then restored therefrom. Then, after a failure C shown in FIG. 4 occurs and then restored therefrom, a monitoring operation shown in FIG. 5 is performed. In the examples shown in FIGS. 2 to 5, the network monitoring device 11 acquires, as the monitoring data, (a) the traffic volume, (b) the packet loss amount, (c) the processing time, (d) the CPU usage rate, (e) the memory occupancy rate, and (f) the cache usage rate. The data size of these monitoring data is (a) 5 bytes for the traffic volume, (b) 5 bytes for the packet loss amount, (c) 5 bytes for the processing time, (d) 10 bytes for the CPU usage rate, (e) 10 bytes for the memory occupancy rate, and (f) 20 bytes for the cache usage rate.

In the example shown in FIG. 2, it is assumed that the failure A has occurred in the network equipment 21 while the network monitoring system 10 that is operating normally is monitoring the network equipment 21, 22, and 23. Further, in the example shown in FIG. 2, it is assumed that the monitoring frequencies are not optimized.

First, the network monitoring device 11 monitors, as an initial monitoring mode, all of the monitoring data at every monitoring point in the stable monitoring mode at the same monitoring frequency (180 s cycle). Note that at this point, the sign information of the failure, which is obtained through monitoring, does not exist yet. Therefore, the sign of the failure is not detected and the operation in the sign monitoring mode is not performed.

Assume that as a result of analyzing the monitoring data acquired by the analysis engine 13, an analysis result A indicating that there is a relevancy between (a) the traffic volume and (b) the packet loss amount in terms of the temporal transition that is in association with the behavior of the data and that the behavior of the data that cannot be seen during the normal operation before the failure is detected as regards (c) the processing time can be obtained. This analysis result A is stored in the database 12 as sign information A.

Based on the sign information A, the analysis engine 13 instructs the network monitoring device 11 to change the monitoring frequencies. The monitoring frequencies in the next sign monitoring mode are determined so that the sum of the data size of each monitoring data per unit time (for example, 1 h=3600 s) in the initial monitoring mode is made to be roughly equal to the sum of the data size of each monitoring data per unit time in the next sign monitoring mode. In the sign monitoring mode, the monitoring data in which the sign of failure can be detected (that is, the relevant monitoring data related to the failure) takes precedence over other data.

Therefore, in the example shown in FIG. 2, (a) the traffic volume, (b) the packet loss amount, and (c) the processing time become the relevant monitoring data that should be acquired in the next sign monitoring mode. The analysis engine 13 changes the monitoring frequencies of the plurality of the monitoring data so as to acquire only the relevant monitoring data related to the failure among the plurality of monitoring data and to avoid acquiring the monitoring data other than the relevant monitoring data in the next sign-indication state. Further, the monitoring frequency of each monitoring data in the sign monitoring mode is higher than the monitoring frequency thereof in the stable monitoring mode. That is, the acquisition cycle of the monitoring data in the sign monitoring mode is shorter than that in the stable monitoring mode.

A data size D1 of the monitoring traffic in the initial monitoring mode can be calculated by the following Expression (1).

D1=5×3600/180)+(5×3600/180)+(5×3600/180)+(10×3600/180)+(10×3600/180)±(20×3600/180)=1100 . . . (1)

In order to make the data size roughly equal to the data size calculated above, the monitoring frequencies in the next sign monitoring mode can be determined to be, for example, (a) 40 s cycle for the traffic volume, (b) 40 s cycle for the packet loss amount, and (c) 90 s cycle for the processing time. Note that in the next sign monitoring mode, the monitoring data other than the relevant monitoring data, which is not used in analyzing the sign of occurrence of the failure, ((d) the CPU usage rate, (e) the memory occupancy rate, and (f) the cache usage rate) is not acquired.

The data size D2 of the monitoring traffic in the next sign monitoring mode is calculated by the following Expression (2).

D2=(5×3600/40)±(5×3600/40)±(5×3600/90)=1100 . . . (2)

As shown in the Expressions (1) and (2), the data size D2 of the monitoring traffic in the next sign monitoring mode is equal to the data size D1 of the monitoring traffic in the initial monitoring mode. As described above, by optimizing the monitoring frequencies so that the monitoring traffic per unit time becomes constant, it is possible to suppress an increase in the load imposed on the network.

After the cause of the failure A of the network equipment 21 is identified, the network monitoring system 10 resumes its normal operation after the recovery operation such as replacing the equipment is performed. FIG. 3 shows the monitoring state in which the result of the analysis of the failure A that has occurred in the network equipment 21 is learned in the sign monitoring mode. In the example shown in FIG. 3, it is assumed that while monitoring the network equipment 21, 22, and 23 during the normal operation of the network monitoring system 10, a sign of occurrence of a failure is detected and the mode transits to the sign monitoring mode, and then a new failure B occurs in the network equipment 22.

The network monitoring device 11 monitors all of the monitoring data at every monitoring point at the monitoring frequency of same cycle (180 s cycle) in the stable monitoring mode. Then, assume that as a result of analyzing the monitoring data acquired by the analysis engine 13, an analysis result B indicating that there is a relevancy between (a) the traffic volume and (b) the packet loss amount as regards the temporal transition and that there is a relevancy among (c) the processing time, (d) the CPU usage rate, and (e) the memory occupancy rate as regards the temporal transition is obtained. The analysis result B is accumulated in the database 12 as the sign information B along with the analysis result A.

Based on these sign information A and B, the analysis engine 13 instructs the network monitoring device 11 to change the monitoring frequencies. The monitoring frequencies are changed so that the sums of the data size of each monitoring data per unit time before and after the monitoring frequencies are changed (the data size of the monitoring traffic) become roughly equal. That is, the sum of the data size of each monitoring data per unit time is not changed from that in the initial monitoring mode.

In the example shown in FIG. 3, similarly to the example shown in FIG. 2, there is a relevancy between (a) the traffic volume and (b) the packet loss amount as well a relevancy among (c) the processing time, (d) the CPU usage rate, and (e) the memory occupancy rate. Therefore, these monitoring data ((a) the traffic volume (b) the packet loss amount, (c) the processing time, (d) the CPU usage rate, and (e) the memory occupancy rate) become the relevant monitoring data. [0033]

As described above, the relevancy between (a) the traffic volume and (b) the packet loss amount is present in the failure B likewise the failure A. Therefore, the analysis engine 13 instructs the network monitoring device 11 to increase the monitoring frequencies of (a) the traffic volume and (b) the packet loss amount among the monitoring frequencies of the plurality of monitoring data in the next stable monitoring mode. On the other hand, as regards both of the failures A and B, since there is no sign information of (f) the cache usage rate, the monitoring frequency thereof is lowered. Further, in this example, the monitoring frequencies of (c) the processing time, (d) the CPU usage rate, and (e) the memory occupancy rate in the stable monitoring mode are not changed.

The monitoring frequencies in the next stable monitoring mode can be determined to be, for example, (a) 140 s cycle for the traffic volume, (b) 140 s cycle for the packet loss amount, (c) 180 s cycle for the processing time, (d) 180 s cycle for the CPU usage rate, (e) 180 s cycle for the memory occupancy rate, and (f) 210 s cycle for the cache usage rate so that the data size becomes roughly equal to that in the initial monitoring mode.

The data size D3 of the monitoring traffic in the next stable monitoring mode is calculated by the following Expression (3).

D3=(5×3600/140)+(5×3600/140)+(5×3600/180)+(1×3600/180)+(10×3600/180)+(20×3600/210)=1100 . . . (3)

As shown in the Expressions (1) and (3), the data size D3 of the monitoring traffic in the next stable monitoring mode is equal to the data size D1 of the monitoring traffic in the initial monitoring mode.

Further, the analysis engine 13 changes the monitoring frequencies of the plurality of the monitoring data so as to acquire only the relevant monitoring data ((a) the traffic volume, (b) the packet loss amount, (c) the processing time, (d) the CPU usage rate, and (e) the memory occupancy rate) related to the failure among the plurality of monitoring data and to avoid acquiring the monitoring data other than the relevant monitoring data ((f) the cache usage rate) in the next sign monitoring mode.

Since there is a relevancy among (c) the processing time, (d) the CPU usage rate, and (e) the memory occupancy rate, the monitoring frequencies of these items are made higher the monitoring frequency (180 s cycle) in the next stable monitoring mode. Further, as regards (a) the traffic amount and (b) the packet loss amount, since there is a relevancy therebetween in both of the failures A and B, the monitoring frequencies thereof are increased compared to the monitoring frequencies of (c) the processing time, (d) the CPU usage rate, and (e) the memory occupancy rate within the range that does not exceed the monitoring frequency in the next stable monitoring mode (140 s cycle). Note that (f) the cache usage rate, which is the data other than the relevant monitoring data, is not acquired in the next sign monitoring mode.

The monitoring frequencies in the next sign monitoring mode can be determined to be, for example, (a) 90 s cycle for the traffic volume, (b) 90 s cycle for the packet loss amount, (c) 128 s cycle for the processing time, (d) 128 s cycle for the CPU usage rate, and (e) 128 s cycle for the memory occupancy rate, so that the data size becomes roughly equal to that in the initial monitoring mode.

The data size D4 of the monitoring traffic in the next sign monitoring mode is calculated by the following Expression (4).

D4=(5×3600/90)+(5×3600/90)+(5×3600/128)+(1×3600/12)+(10×3600/128)≈1100 . . . (4)

As shown in the Expressions (1) and (4), the data size D4 of the monitoring traffic in the next sign monitoring mode is roughly equal to the data size D1 of the monitoring traffic in the initial monitoring mode.

As described above, when a transition is made from the stable state to, via the sign-indication state, the abnormality state, the monitoring frequencies of the plurality of monitoring data in the stable state (the stable monitoring mode) and the monitoring frequencies of the relevant monitoring data in the next sign-indication state (the sign monitoring mode) are changed. As described above, in the network monitoring system according to the example embodiment, an increase in the load imposed on the network is prevented by making the monitoring traffic per unit time substantially constant without having to delete the plurality of monitoring data (the monitoring items) that are monitored in the stable monitoring mode. Further, in the sign monitoring mode, by acquiring only the monitoring data from which a sign of a failure can be detected, the accuracy of the detection of the sign of the failure can be increased.

After the cause of the failure B of the network equipment 22 is identified, the network monitoring system 10 resumes its normal operation after the recovery operation such as replacing the equipment is performed. FIG. 4 shows the monitoring state in which the result of the analysis of the failure B is learned in addition to the result of the analysis of the failure A in the stable monitoring mode and the sign monitoring mode. In the example shown in FIG. 4, it is assumed that while the network equipment 21, 22, and 23 are monitored during the normal operation of the network monitoring system 10, a sign of occurrence of a failure is detected and the mode transits to the sign monitoring mode, and then a new failure C occurs in the network equipment 23.

In the stable monitoring mode, the network monitoring device 11 monitors all of the monitoring data at every monitoring point at the prescribed monitoring frequencies shown in FIG. 4. Then, assume that as a result of analyzing the monitoring data acquired by the analysis engine 13, an analysis result C indicating that there is a relevancy between (a) the traffic volume and (b) the packet loss amount as regards the temporal transition is obtained. The analysis result C is accumulated in the database 12 as the sign information C along with the analysis results A and B.

Based on these sign information A, B, and C, the analysis engine 13 instructs the network monitoring device 11 to change the monitoring frequencies. As described above, the monitoring frequencies are changed so that the sums of the data size of each monitoring data per unit time before and after the monitoring frequencies are changed (the data size of the monitoring traffic) become roughly equal.

In the example shown in FIG. 4, similarly to the examples shown in FIGS. 2 and 3, there is a relevancy between (a) the traffic volume and (b) the packet loss amount. Therefore, the analysis engine 13 instructs the network monitoring device 11 to increase the monitoring frequencies of (a) the traffic volume and (b) the packet loss amount among the monitoring frequencies of the plurality of monitoring data in the next stable monitoring mode.

On the other hand, as regards the failures A, B, and C, since there is no sign information of (f) the cache usage rate, the monitoring frequency thereof is lowered. Further, in this example, the monitoring frequencies of (c) the processing time, (d) the CPU usage rate, and (e) the memory occupancy rate in the stable monitoring mode are not changed.

The monitoring frequencies in the next stable monitoring mode can be determined to be, for example, (a) 100 s cycle for the traffic volume, (b) 100 s cycle for the packet loss amount, (c) 180 s cycle for the processing time, (d) 180 s cycle for the CPU usage rate, (e) 180 s cycle for the memory occupancy rate, and (f) 300 s cycle for the cache usage rate, so that the data size becomes roughly equal to that in the initial monitoring mode.

The data size D5 of the monitoring traffic in the next stable monitoring mode is calculated by the following Expression (5).

D5=(5×3600/100)+(5×3600/100)+(5×3600/180)+(1×3600/180)+(10×3600/180)+(20×3600/300)=1100 . . . (5)

As shown in the Expressions (1) and (5), the data size D5 of the monitoring traffic in the next stable monitoring mode is equal to the data size D1 of the monitoring traffic in the initial monitoring mode.

Further, the analysis engine 13 changes the monitoring frequencies of the plurality of the monitoring data so as to acquire only the relevant monitoring data ((a) the traffic volume, (b) the packet loss amount, (c) the processing time, (d) the CPU usage rate, and (e) the memory occupancy rate) related to any one of the failures A, B, or C that has occurred in the past and to avoid acquiring the monitoring data other than the relevant monitoring data ((f) the cache usage rate) in the next sign monitoring mode.

Further, as regards (a) the traffic amount and (b) the packet loss amount, since there is a relevancy therebetween in all of the failures A, B, and C, the monitoring frequencies thereof are increased in the next sign monitoring mode. Further, as regards (c) the processing time, (d) the CPU usage rate, and (e) the memory occupancy rate among which there was a relevancy only in the failure B, the monitoring frequencies thereof are adjusted within the range that does not exceed the monitoring frequency in the next stable monitoring mode (180 s cycle). Note that (f) the cache usage rate, which is data other than the relevant monitoring data, is not acquired in the next sign monitoring mode.

The monitoring frequencies in the next sign monitoring mode can be determined to be, for example, (a) 80 s cycle for the traffic volume, (b) 80 s cycle for the packet loss amount, (c) 138 s cycle for the processing time, (d) 138 s cycle for the CPU usage rate, and (e) 138 s cycle for the memory occupancy rate, so that the data size becomes roughly equal to that in the initial monitoring mode.

The data size D6 of the monitoring traffic in the next sign monitoring mode is calculated by the following Expression (6).

D6=(5×3600/80)+(5×3600/80)+(5×3600/138)+(10×3600/138)+(10×3600/138)≈1100 . . . (6)

As shown in the Expressions (1) and (6), the data size D6 of the monitoring traffic in the next sign monitoring mode is roughly equal to the data size D1 of the monitoring traffic in the initial monitoring mode.

After the cause of the failure C of the network equipment 23 is identified, the network monitoring system 10 transits to the normal operation after the recovery operation such as replacing the equipment is performed.

As described above, by analyzing the monitoring data every time a failure occurs and learning the analysis result, it becomes possible to optimize the monitoring frequency of each monitoring data as shown in FIG. 5 from the monitoring frequency of each monitoring data in the initial monitoring mode. In the example described above, since the frequency of occurrence of failures is high for (a) the traffic volume and (b) the packet loss amount, the monitoring frequencies in both the stable monitoring mode and the sign monitoring mode become high whereby accuracy in detecting an abnormality becomes high. Further, as regards the failures A, B, and C that have occurred in the past, it is possible to specify the causes of the failures before they occur at the time of sign detection.

In the network monitoring system 10 according to the example embodiment, analysis of the monitoring data is repeated every time a failure occurs and the acquisition frequency of each of the plurality of monitoring data at every monitoring point at which a failure may possibly occur is changed. That is, the network monitoring system 10 can gradually move-up the detection timing of the signs of failures in view of the actual failures that have occurred in the past. That is, the network monitoring device can detect an abnormality of the system as early as possible without having to acquire the monitoring state at a high frequency (for example, in an order of several seconds). Accordingly, within a range where the number of monitoring points at which the network equipment falls in a sign-indication state or an abnormal state are relatively few, it is possible to prevent, in total, the load imposed on the network due to the acquisition of the monitoring data of the network equipment and to reduce the influence on the data communication at the user's end.

Further, in the sign monitoring mode, it is possible to increase the acquisition frequency of the monitoring data at the monitoring points related to the failure. Accordingly, even when the network equipment affect each other due to the complication of the network system, it is possible to suppress delay in the detection of the failures by grasping the correlation among the monitoring data related to the failures.

Further, conventionally, the monitoring items to be monitored and collected on the network monitoring device side were determined in advance at the time setting thereof, and it was necessary to make changes so as to collect data of the new monitoring item every time an unexpected failure occurs. On the other hand, in the network monitoring system 10 according to the example embodiment, the logs of all monitoring data in every monitoring point including the logs which are unclear as to whether they are necessary in detecting an abnormality in the system are made to be the target of collection from the network equipment. With this configuration, it is possible to cope with the case where unexpected failures occurs.

Note that the present disclosure is not limited to the above-described example embodiments, and various modifications can be made without departing from the spirit and scope of the present disclosure. It is also possible to change the monitoring frequency of each monitoring data by detecting not only the monitoring data from the target monitoring equipment but also the load imposed on the network due to an external factor. For example, by grasping the status of an event that is using the internet or when information that the network load is going to increase due to a concentration in the server access is obtained, the analysis engine 13 instructs the network monitoring device 11 to increase the monitoring frequency of the network equipment in that area, whereby even when a failure occurs, it is possible to lessen the influence of the failure.

As described above, the present disclosure has been described above with reference to the example embodiments. However, the present disclosure is not limited to the above example embodiments. Note that the configuration and details of the present disclosure can be changed in various ways within scope of the disclosure that can be understood by a skilled person.

This application is based upon and claims the benefit of priority from Japanese patent application No. 2018-007568, filed on Jan. 19, 2018, the disclosure of which is incorporated herein in its entirety by reference.

### REFERENCE SIGNS LIST

10 NETWORK MONITORING SYSTEM
11 NETWORK MONITORING SYSTEM
12 DATABASE
13 ANALYSIS ENGINE
20 INTERNET NETWORK
21 NETWORK EQUIPMENT
22 NETWORK EQUIPMENT
23 NETWORK EQUIPMENT

1. A network monitoring system that monitors a monitoring target equipment connected via a network, comprising:
a network monitoring device configured to acquire a plurality of monitoring data related to a state of the monitoring target equipment at respective prescribed monitoring frequencies;
an analysis device configured to analyze the plurality of monitoring data up to a time of occurrence of a failure in the monitoring target equipment and create sign information of the occurrence of the failure every time a failure occurs in the monitoring target equipment; and
a storage device configured to accumulate the sign information that is created, wherein
the analysis device is configured to change each of the monitoring frequencies of the plurality of monitoring data based on the sign information that is accumulated.

2. The network monitoring system according to claim 1, wherein the analysis device is configured to
learn a behavior of each of the plurality of monitoring data in each of a stable state in which no failure has occurred, a sign-indication state in which a failure is about to occur, and an abnormality state in which a failure has occurred and determine which one of the stable state, the sign-indication state, or the abnormality state a network equipment is in, and
switch between a stable monitoring mode in which the plurality of monitoring data is acquired in the stable state and a sign monitoring mode in which relevant monitoring data related to a failure that occurred in the sign-indication state is acquired.

3. The network monitoring system according to claim 2, wherein the monitoring frequency of each of the plurality of monitoring data in the sign monitoring mode is higher than the monitoring frequency in the stable monitoring mode.

4. The network monitoring system according to claim 2, wherein the monitoring frequencies of the plurality of monitoring data in the next stable state and the monitoring frequencies of the plurality of monitoring data in the next sign-indication state are changed, respectively, when a transition is made from the stable state to, via the sign-indication state, the abnormality state.

5. The network monitoring system according to claim 4, wherein the analysis device changes the monitoring frequencies of the plurality of monitoring data so as to acquire only the relevant monitoring data related to the failure among the plurality of monitoring data and avoid acquiring the monitoring data other than the relevant monitoring data in the next sign-indication state.

6. The network monitoring system according to claim 1, wherein the analysis device changes the monitoring frequencies so that the sums of the plurality of monitoring data per unit time before and after changing the monitoring frequencies become roughly equal.

7. A network monitoring method that monitors a monitoring target equipment connected via a network, comprising the steps of:
acquiring a plurality of monitoring data related to a state of the monitoring target equipment at respective prescribed monitoring frequencies;
analyzing the plurality of monitoring data up to a time of occurrence of a failure in the monitoring target equipment, creating sign information of the occurrence of the failure every time a failure occurs in the monitoring target equipment, and accumulating the sign information that is created; and
changing each of the monitoring frequencies of the plurality of monitoring data based on the sign information that is accumulated.

8. A non-transitory computer-readable medium storing a network monitoring program for monitoring target equipment connected via a network, the program causing a computer to perform the processes of:
acquiring a plurality of monitoring data related to a state of the monitoring target equipment at respective prescribed monitoring frequencies;
analyzing the plurality of monitoring data up to a time of occurrence of a failure in the monitoring target equipment, creating sign information of the occurrence of the failure every time a failure occurs in the monitoring target equipment, and accumulating the sign information that is created; and
changing each of the monitoring frequencies of the plurality of monitoring data based on the sign information that is accumulated.
